(19) United States
(12) Patent Application Publication
(10) Pub. No.: US 2013/0038191 A1
(43) Pub. Date: Feb. 14, 2013

(54) HINGE AND PORTABLE DEVICE WITH THE SAME

(71) Applicants: TING-HSIEN WANG, NEW TAIPEI (TW); CHIEH HUANG, NEW TAIPEI (TW); SHAN-YI YANG, NEW TAIPEI (TW)

(72) Inventors: TING-HSIEN WANG, NEW TAIPEI (TW); CHIEH HUANG, NEW TAIPEI (TW); SHAN-YI YANG, NEW TAIPEI (TW)

(73) Assignee: SHIN ZU SHING CO., LTD., NEW TAIPEI (TW)

(21) Appl. No.: 13/206,275

(22) Filed: Aug. 9, 2011

(51) Int. Cl. A47B 96/00; E05D 11/10

(52) U.S. Cl. 312/326; 16/319

(57) ABSTRACT

A hinge is mounted between a cover and a base of a portable device and has a first connecting element, a second connecting element and a pintle. The first connecting element is attached securely to the cover. The second connecting element is attached securely to the base. The pintle is hollow and is mounted through the first and second connecting elements. The wires of the portable device are mounted through the hollow pintle so that the rooms for the wires and for the pintle are overlapped. Therefore, the room occupied by the wires is decreased and the volume of the portable device is also reduced.

### BACKGROUND OF THE INVENTION

1. Field of the Invention

The present invention relates to a hinge, especially to a hinge mounted between a cover and a base of a portable device to allow the cover to pivot relative to the base.

2. Description of the Prior Arts

Hinges are connected between two elements to allow the elements to pivot relative to each other. In particular, the hinges are widely used in portable devices.

With reference to FIG. 12, a conventional hinge comprises a pintle 60 and a sleeve 70. The sleeve 70 is formed by bending a resilient sheet. The inner diameter of the sleeve 70 is smaller than the outer diameter of the pintle 60 and has a slit 701. The slit 701 allows the sleeve 70 to be expanded for tightly mounting around the pintle 60. When the pintle 60 is rotated relative to the sleeve 70, the pintle 60 rubs against the sleeve 70 to generate torque so that the cover of the portable device can he held at a desired visual angle.

Further, the pintle 60 of the conventional hinge is a solid metal rod. The portable device needs wires to electrically connect the cover and the base. Since the conventional hinge is mounted between the cover and the base, the wires need to be wound around the conventional hinge such that the portable device needs room to receive those wires. The wires may also be damaged while being wound around the conventional hinge. Additionally, because the cover is connected pivotally to the base, the wires need to have spare length to allow the rotation. Therefore, more room should be saved in the cover or the base for those wires with spare length to keep the wires from accidentally intertwining with other elements.

However, as people require the portable devices to be miniaturized, the room for receiving the wires becomes obstructions in decreasing the volume of the portable devices.

To overcome the shortcomings, the present invention provides a hinge to mitigate or obviate the aforementioned problems.

### SUMMARY OF THE INVENTION

The main objective of the present invention is to provide a hinge to reduce the volume of the portable device. The hinge is mounted between a cover and a base of a portable device and has a first connecting element, a second connecting element and a pintle. The first connecting element is attached securely to the cover. The second connecting element is attached securely to the base. The pintle is hollow and is mounted through the first and second connecting elements. The wires of the portable device are mounted through the hollow pintle so that the rooms for the wires and for the pintle are overlapped. Therefore, the room occupied by the wires is decreased and the volume of the portable device is also reduced.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge in accordance with the present invention;

FIG. 2 is an exploded perspective view of the hinge in FIG. 1;

FIG. 3 is a side view in partial section of the hinge in FIG. 1;

FIG. 4 is a perspective view of a first connecting element of the hinge in FIG. 1;

FIG. 5 is a side view of the hinge in FIG. 1;

FIG. 6 is an operational perspective view of a portable device in accordance with the present invention with the hinge in FIG. 1, shown closed;

FIG. 7 is an operational perspective view of the portable device in FIG. 6, shown open;

FIG. 8 is an operational end view of the hinge in FIG. 1, shown open;

FIG. 9 is a perspective view of another embodiment of a hinge in accordance with the present invention;

FIG. 10 is an exploded perspective view of the hinge in FIG. 9;

FIG. 11 is a side view of the hinge in FIG. 9; and

FIG. 12 is an exploded perspective view of a conventional hinge in accordance with the prior art.

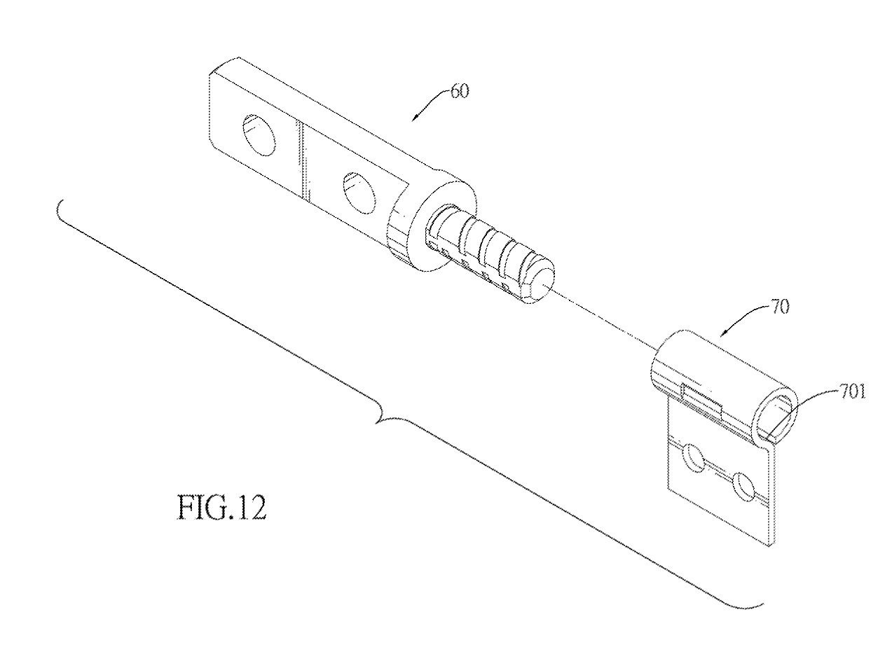

### DETAILED DESCRIPTION OF THE PREFERRED EMBODIMENTS

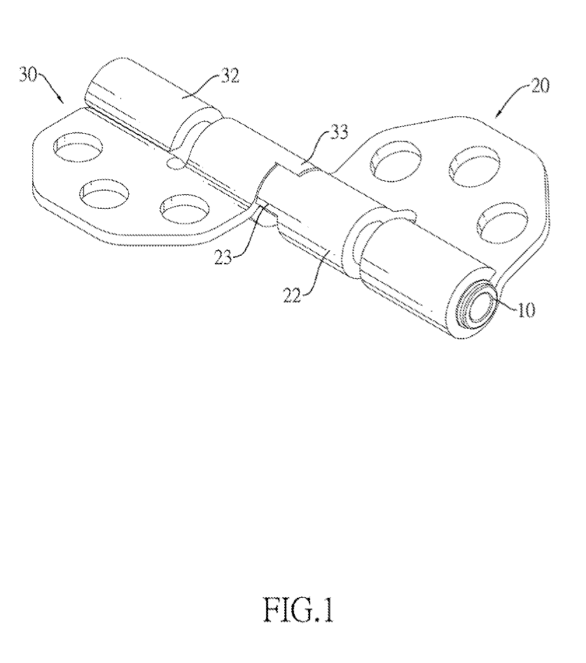

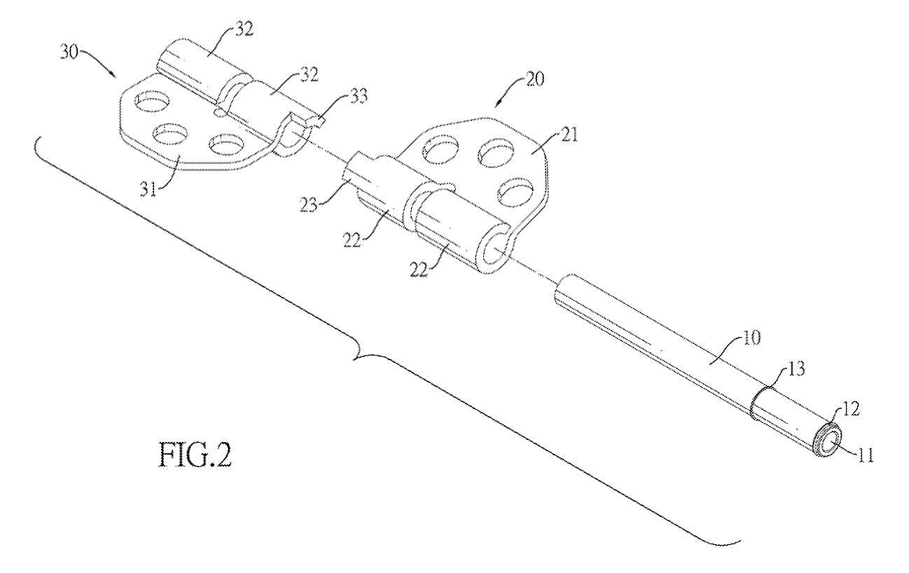

With reference to FIGS. 1 and 2, a hinge in accordance with the present invention comprises a pintle 10, a first connecting element 20 and a second connecting element 30.

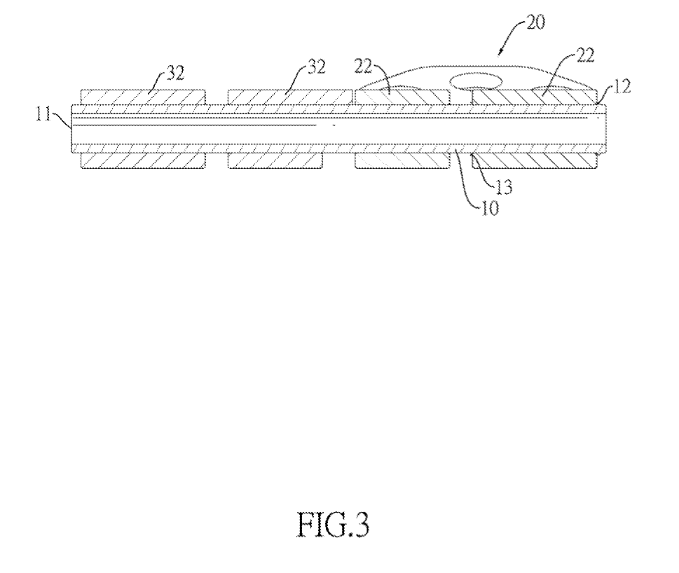

With reference to FIGS. 2 and 3, the pintle 10 is hollow and has two end openings 11, a first annular flange 12 and a second annular flange 13. The first annular flange 12 is formed around an outside wall of the pintle 10 near one of the end openings 11. The second annular flange 13 is formed around the outside wall of the pintle 10 and is separated from the first annular flange 12.

The first and second connecting elements 20, 30 are mounted around the pintle 10. Each connecting element 20, 30 has an extending wing 21, 31 and at least one sleeve 22, 32. The sleeve 22 of the first connecting element 20 abuts the first or second annular flange 12, 13 of the pintle 10 to keep the sleeve 22 of the first connecting element 20 from departing from the pintle 10 or deviating from the predetermined position. In a preferred embodiment, the sleeve 22 of the first connecting element 20 is clamped between the first and second annular flanges 12, 13 of the pintle 10.

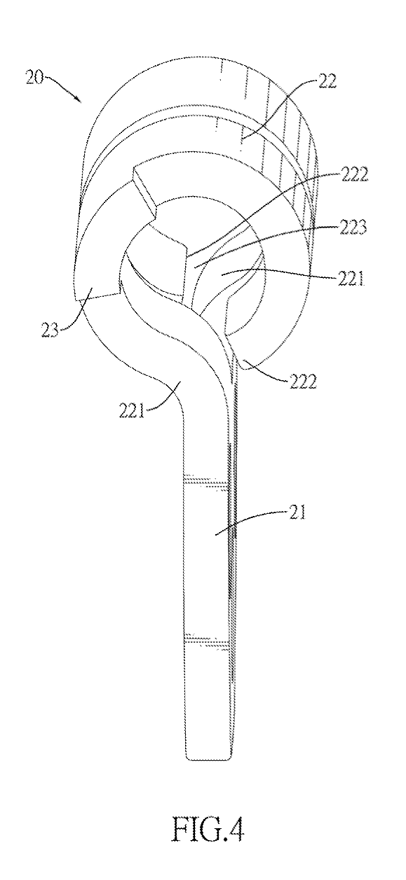

With reference to FIGS. 2 and 4, the sleeve 22, 32 of each connecting element 20, 30 is formed by bending from an edge of the extending wing 21, 31. As for the first connecting element 20, the sleeve 22 has a connecting end 221, a free end 222 and a slit 223. The connecting end 221 is connected to the edge of the extending wing 21. The free end 222 is separated from the connecting end 221. The slit 223 is formed between the free end 222 and the connecting end 221 to allow the sleeve 22 to be expanded and extracted. In a preferred embodiment, each connecting element 20 has two separated sleeves 22. The two sleeves 22 are bent in opposite directions so that the slits 223 of the two sleeves 22 misalign with each other to provide a constant torque when the connecting element 20 is rotated in either direction. The sleeve 32 of the second connecting element 30 has the same structure with the sleeve 22 of the first connecting element 20 so that detailed description of the sleeve 32 is omitted.

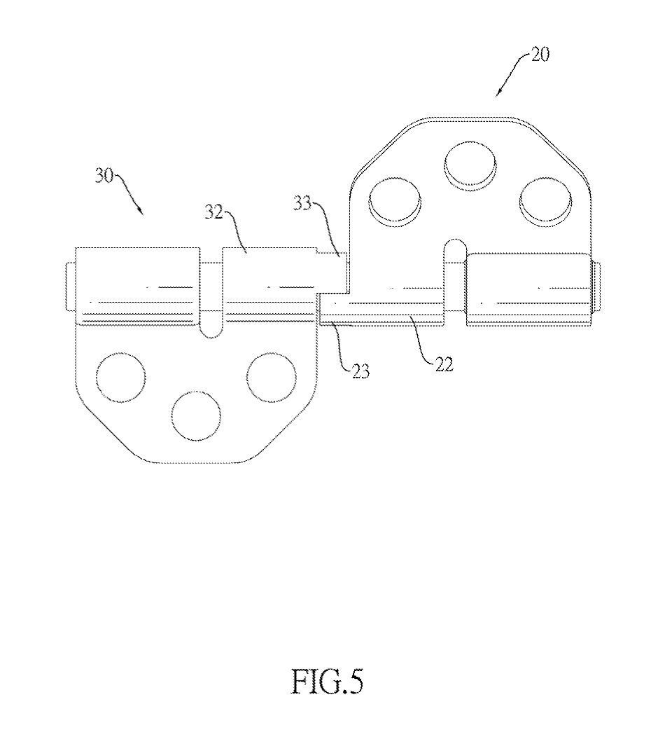

With further reference to FIG. 5, each connecting element 20, 30 has a corresponding end and a limiting protrusion 23, 33. The corresponding ends of the first and second connecting elements 20, 30 face each other. The limiting protrusion 23, 33 of each connecting element 20, 30 is formed on the corresponding end. The limiting protrusions 23, 33 of the first and second connecting elements 20, 30 selectively abut each other to limit the rotating angle of the connecting elements 20, 30.

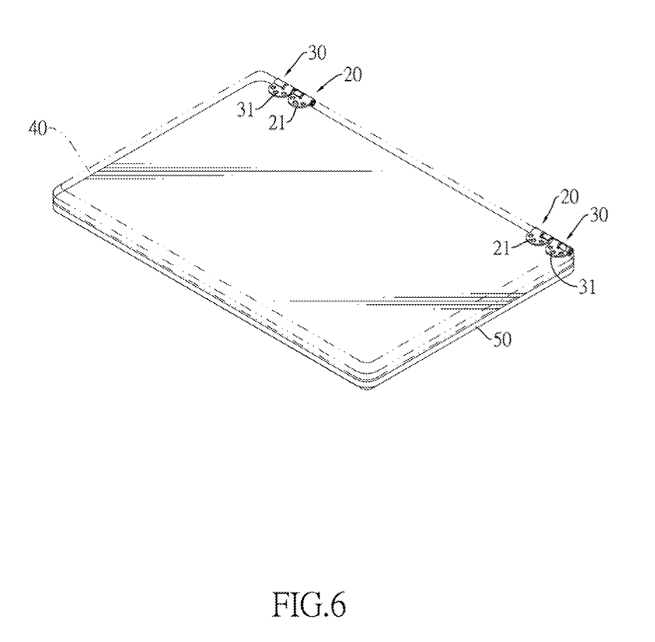

With reference to FIG. 6, a portable device in accordance with the present invention comprises at least one hinge as described, a cover 40 and a base 50. The hinge is mounted between the cover 40 and the base 50. The wires electrically connecting the cover 40 and the base 50 are mounted through the hollow pintle 10 and the end openings 11 so that the room to receive the wires overlaps the room to receive the pintle 10. Therefore, the room occupied by the wires is decreased and the volume of the portable device is also reduced.

The extending wing 21 of the first connecting element 20 is attached securely to the cover 40. The extending wing 31 of the second connecting element 30 is attached securely to the base 50. When the cover 40 and the base 50 are pivoted relative to each other, the first connecting element 20 and the second connecting element 30 are rotated relative to each other. Since the cover 40 is usually pivoted and the base 50 is usually held still, the first connecting element 20 is usually rotated and the second connecting element 30 is usually held still. Therefore, the first and second annular flanges 12, 13 keep the first connecting element 20 from departing from the pintle 10 when the first connecting element 20 is rotated. The second connecting element 30 may also have annular flanges to keep the second connecting clement 30 from accidentally departing from the pintle 10.

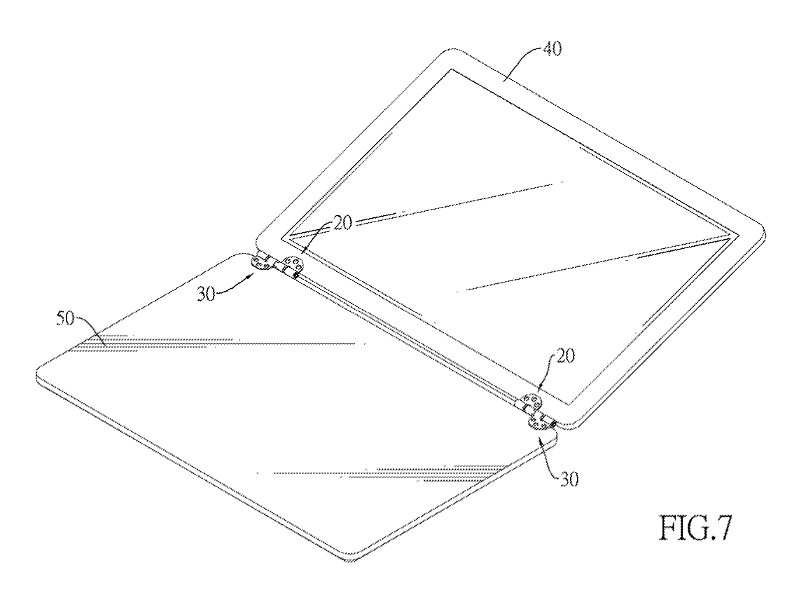

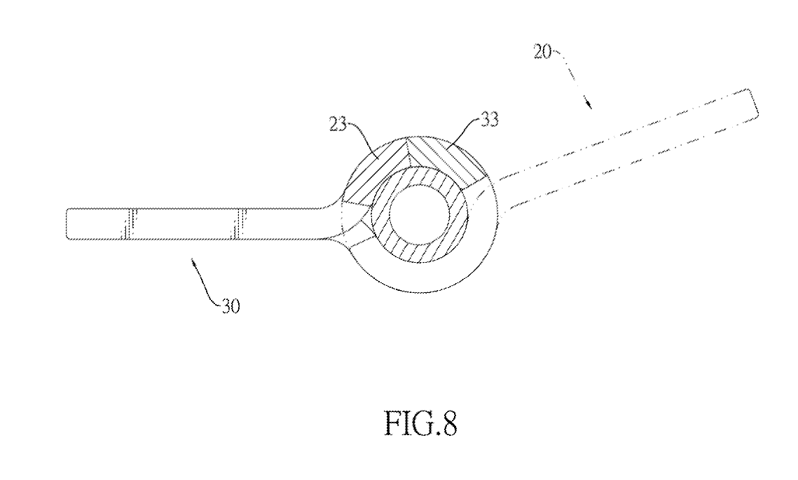

With reference to FIGS. 5, 7 and 8, when the cover 40 is open and the limiting protrusions 23, 33 of the first and second connecting elements 20, 30 abut each other, the cover 40 is limited from further rotation.

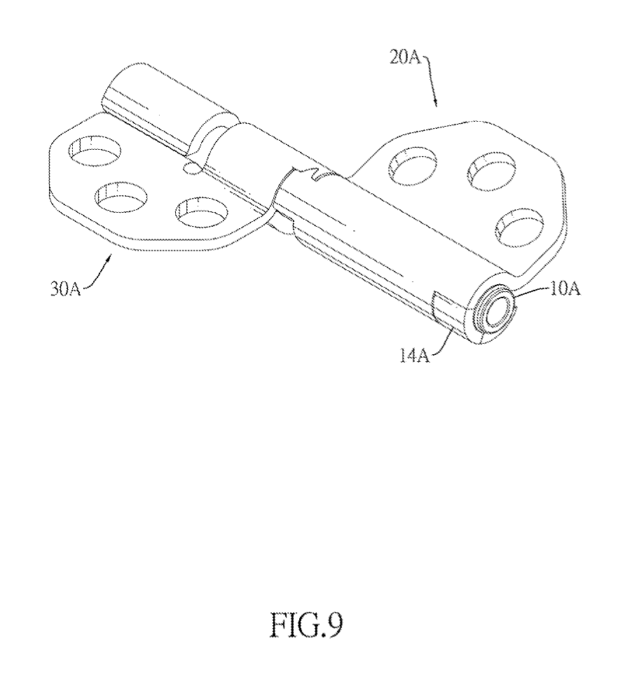

With reference to FIGS. 9 to 11, another embodiment of a hinge in accordance with the present invention is similar to the hinge shown in FIG. 1 and has some different structures to provide additional functions.

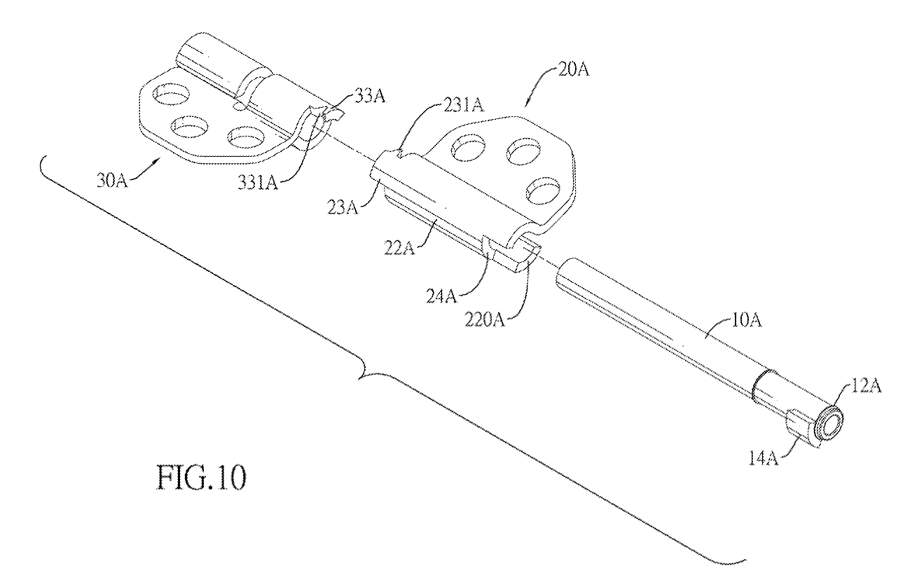

With reference to FIGS. 9 and 10, the pintle 10A has a keyed protrusion 14A formed on the outside wall of the pintle 10A and near the first annular flange 12A. The first connecting element 20A has a keyed recess 24A formed on an outer end 220A of the sleeve 22A and engaging the keyed protrusion 14A of the pintle 10A to further prevent the first connecting element 20A from departing from the pintle 10A.

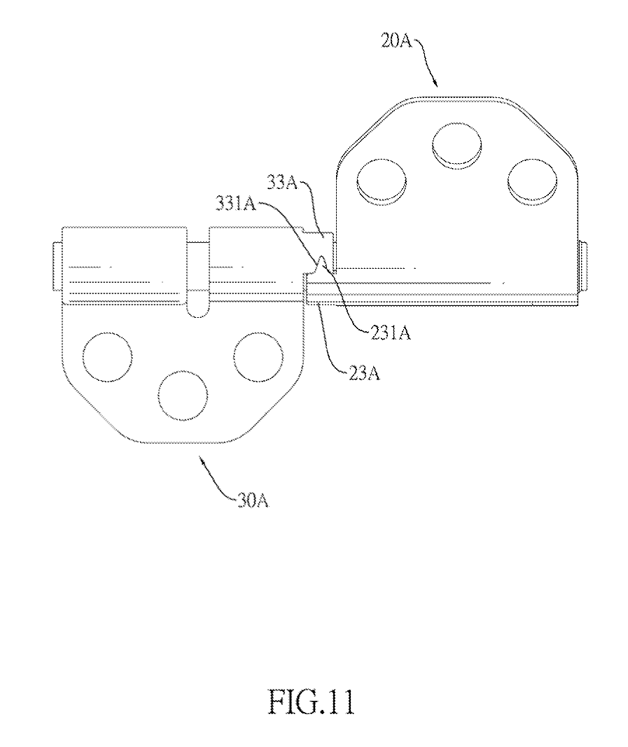

With reference to FIGS. 10 and 11, a first positioning member is formed on the limiting protrusion 23A of the first connecting element 20A. A second positioning member is formed on the limiting protrusion 33A of the second connecting element 30A and selectively engages the first positioning member of the first connecting element 20A. When the first and second connecting elements 20A, 30A are rotated relative to each other and the limiting protrusions 23A, 33A approach gradually close to each other, the first and second positioning members approach gradually close to each other until engaging with each other. The engagement of the positioning members forces the first and second connecting elements 20A, 30A to move back to their original positions to prevent the first and second connecting elements 20A, 30A from deviating from the predetermined relative positions or departing from the pintle 10A. Moreover, the positioning members gradually engaging with each other generate positioning function to keep the user from overloading to break the limiting protrusions 23A, 33A. In a preferred embodiment, the first positioning member of the first positioning connecting element 20A is a positioning protrusion 231A, and the second positioning member of the second positioning connecting element 30A is a detent 331A.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a hollow pintle having two end openings;
a first connecting element mounted around the pintle and having an extending wing;
at least one sleeve formed by bending from an edge of the extending wing;
a limiting protrusion formed on an abutting end of the first connecting element; and
a positioning protrusion formed on the limiting protrusion; and
a second connecting element mounted around the pintle and having an abutting end facing the abutting end of the first connecting element;
an extending wing;
at least one sleeve formed by bending from an edge of the extending wing;
a limiting protrusion formed on the abutting end of the second connecting element and selectively abutting the limiting protrusion of the first connecting element; and
a detent formed on the limiting protrusion of the second connecting element and selectively engaging the positioning protrusion of the first connecting element.

2. The hinge as claimed in claim 1, wherein
the pintle has a first annular flange formed around an outside wall of the pintle near one of the end openings; and
one of the at least one sleeve of the first connecting element abuts the first annular flange of the pintle.

3. The hinge as claimed in claim 2, wherein
the pintle has a second annular flange formed around the outside wall of the pintle and separated from the first annular flange; and
the at least one sleeve of the first connecting element is clamped between the first and second annular flanges of the pintle.

4. The hinge as claimed in claim 1, wherein
the pintle has a keyed protrusion formed on the outside wall of the pintle; and
the first connecting element has a keyed recess formed on an outer end of one of the at least one sleeve and engaging the keyed protrusion of the pintle.

5. The hinge as claimed in claim 2, wherein
the pintle has a keyed protrusion formed on the outside wall of the pintle and near the first annular flange; and
the first connecting element has a keyed recess formed on an outer end of one of the at least one sleeve and engaging the keyed protrusion of the pintle.

6. The hinge as claimed in claim 3, wherein
the pintle has a keyed protrusion formed on the outside wall of the pintle and near the first annular flange; and
the first connecting element has a keyed recess formed on an outer end of one of the at least one sleeve and engaging the keyed protrusion of the pintle.

7. The hinge as claimed in claim 1, wherein each one of the at least one sleeve of each connecting element has
a connecting end connected to the edge of the extending wing;
a free end separated from the connecting end; and
a slit formed between the free end and the connecting end.

8. The hinge as claimed in claim 4, wherein each one of the at least one sleeve of each connecting element has
a connecting end connected to the edge of the extending wing;
a free end separated from the connecting end; and
a slit formed between the free end and the connecting end.

9. The hinge as claimed in claim 6, wherein each one of the at least one sleeve of each connecting element has
a connecting end connected to the edge of the extending wing;
a free end separated from the connecting end; and
a slit formed between the free end and the connecting end.

10. The hinge as claimed in claim 7, wherein each connecting element has two separated sleeves bent in opposite directions, and the slits 223 of the two sleeves of each connecting element misalign with each other.

11. The hinge as claimed in claim 8, wherein each connecting element has two separated sleeves bent in opposite directions, and the slits 223 of the two sleeves of each connecting element misalign with each other.

12. The hinge as claimed in claim 9, wherein each connecting element has two separated sleeves bent in opposite directions, and the slits 223 of the two sleeves of each connecting element misalign with each other.

13. A portable device with at least one hinge as claimed in claim 1 comprising
a cover;
a base connected pivotally to the cover;
the at least one hinge connected between the cover and the base;
the extending wing of the first connecting element of the at least one hinge attached securely to the cover; and
the extending wing of the second connecting element of the at least one hinge attached securely to the base.

14. A portable device with at least one hinge as claimed in claim 4 comprising
a cover;
a base connected pivotally to the cover;
the at least one hinge connected between the cover and the base;
the extending wing of the first connecting element of the at least one hinge attached securely to the cover; and
the extending wing of the second connecting element of the at least one hinge attached securely to the base.
